(19) United States
(12) Patent Application Publication
(10) Pub. No.: US 2011/0153526 A1
(43) Pub. Date: Jun. 23, 2011

(54) Static Ad Frame

(76) Inventors: Howard R. Hochhalter, Ellenton, FL (US); Sean P. Thorp, Palm Harbor, FL (US); Mark S. Carson, St. Petersburg, FL (US)

(21) Appl. No.: 12/987,156

(22) Filed: Jan. 9, 2011

Related U.S. Application Data
(63) Continuation-in-part of application No. 12/539,613, filed on Aug. 12, 2009.
(60) Provisional application No. 61/293,250, filed on Jan. 8, 2010.

(51) Int. Cl. G06Q 90/00; H04N 5/64

(52) U.S. Cl. 705/500; 348/836

(57) ABSTRACT

A static ad frame used vertically and horizontally around the viewing area of a flat panel television or digital display to advertise, promote, market, and/or convey a message to individuals viewing content on the associated flat panel television or digital display via images and/or words printed on the frame's exposed front surface. It is preferably made from lightweight and rigid signboard material, and is attached to the front of the flat panel television or digital display via fastening means. No loss of functionality in the associated flat panel television or digital display occurs, or degradation of performance, as a result of signboard use. Content on the signboard is seen both actively and passively by viewers of the associated flat panel television or digital display. Optionally, a permanent message, an erasable surface that facilitates impromptu/dynamic messaging, lightweight cutouts creating 3-dimensional effects, and accommodation for infrared relay devices, may also be provided.

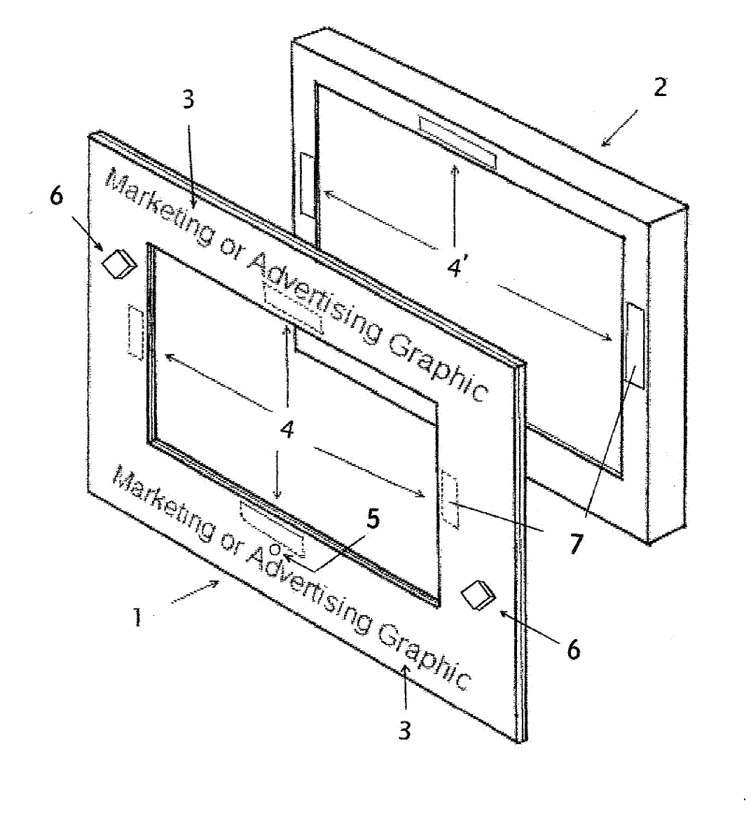

### CROSS-REFERENCES TO RELATED APPLICATIONS

This application is related in subject matter to a currently-pending U.S. provisional patent application 61/293,250 that was filed on Jan. 8, 2010, by the same three inventors identified therein, with the title of “Signboard used vertically and horizontally around the viewing area of a flat panel television or digital display to advertise, promote, market, or convey a message to individuals viewing the content on the flat panel television or digital display”. Furthermore, the inventors herein additionally request domestic priority based upon a second currently-pending U.S. patent application Ser. No. 12/539,613, which was filed by the same three inventors on Aug. 12, 2009, with the title of “Method of using a flat panel television to deliver digital content to a targeted demographic”, and a third currently-pending U.S. patent application Ser. No. 12/397,280, filed by two of the inventors herein on Mar. 3, 2009, with the title of “Flat panel television accessory mounting bracket and enclosure”, which was preceded by a fourth U.S. patent application which was filed on Mar. 3, 2008 by two of the same inventors herein, with such provisional patent application having the application No. 61/067,837, the title of “Universal Flat Panel Accessory Mounting Bracket”, and a Confirmation Number of 7602. Thus, the inventors herein respectfully request domestic priority for the U.S. non-provisional patent application they are now filing, based upon all the four of the U.S. patent applications identified immediately hereinabove.

### BACKGROUND

1. Field of the Invention

This invention relates to the field of mounting apparatus and accessories for flat panel televisions and digital displays, specifically to a static ad frame made from signboard material that is used vertically and horizontally around the viewing area of a flat panel television or digital display to advertise, promote, market, and/or convey a message to individuals viewing content on the flat panel television or digital display. The compelling attraction and attention-capturing power of television is thus employed to allow advertisers of products and services to reach a targeted demographic with relevant and content-rich high definition printed media that can be seen in any location where a flat panel television or digital display is, or could be, located. Contemplated applications include, but are not limited to, use where content on the associated flat panel television is a how-to-video loop, as well as use on flat panel televisions located at bars, casinos, sporting events, medical offices, shopping malls, airport terminals, and places where large groups of people congregate to attend a theme park, car show, or musical concert. Hereinafter in this disclosure, without any intent of limitation and to avoid the possibility of potentially confusing repletion in the ensuing text, whenever the term ‘flat panel television’ is used, unless specifically noted otherwise, use of the words ‘flat panel television’ should also be considered to include possible use of any other type/source of digital display.

The signboard content in the present invention can be of a general nature, or specific to a targeted demographic, as needed by the owner of the associated flat panel television. In addition, the signboard can have a printable surface usable for establishing a permanent message for viewers of an associated flat panel television, or in the alternative the signboard may optionally have an erasable surface that facilitates impromptu and changeable/dynamic messages and/or advertising in association with a flat panel television. Images, words, or a combination thereof, can be used on the printable surface of the present invention signboard, with such content being seen both actively and passively by individuals while they are viewing the content on the associated flat panel television. Furthermore, lightweight cutouts can be optionally added to the present invention signboard to provide a decorative 3-dimensional effect, and a cut-out added made in the present invention for continued use of an infrared relay device with the flat panel television associated with the face-mounted present invention signboard to maintain remote control functionality.

Thus, the present invention is typically a flat device, not unlike a frame, which is preferably made from lightweight and rigid material having a printable surface, such as but not limited to foam core board, dry erase board, plastic, and/or metal, and which further becomes attached to the front housing of a flat panel television (vertically and horizontally around its viewing area) via anchoring/fastening means. No content on the viewing area of the flat panel television is blocked by the positioning of the present invention, no degradation of flat panel television performance occurs as a result of present invention use, and no loss of flat panel television functionality is experienced when the present invention is used. Furthermore, as a result of the present invention's location only a few inches away from the viewing area of a flat panel television (where a person's attention is primarily focused), self-promoting messages/content, and/or revenue-generating messages/content, printed on the present invention will be continually seen (both actively and passively) as long as the present invention signboard remains in its usable position attached to the front housing of a flat panel television. No other invention is known with the same structural features and low cost option advantage provided by the present invention for placement of messages and/or advertisements in close association with a flat panel television.

2. Description of the Related Art

Advertisers and marketers continue to seek better ways to reach potential markets and consumers. However, when offered a choice to view entertainment content with or without associated advertising content, people generally select entertainment content without advertisements. This preference is illustrated by the success of TIVO-like digital-video-recording (DVR) technology that allows viewers of broadcast television content to bypass commercials and advertisements that would otherwise be present. The present invention static ad frame allows the owners of flat panel televisions located in public areas, such as but not limited to restaurants, bars, and medical offices, to utilize the unused space around the viewing area of the flat panel television for self-promotion, and/or to generate a revenue stream by allocating that unused space to advertisers and marketers. Thus, individuals who own flat panel televisions situated in public settings and who also use a present invention signboard in association with them, can target a particular demographic in ways not possible before, via strategic advertising placed very close to the area where a viewer's attention is continually focused (the viewing area on the flat panel television where informational and/or entertainment content is displayed). Television screens have an almost unnatural ability to attract our attention, and no matter what their content consists of, we find ourselves looking at them, even if only briefly, and giving them our attention. Furthermore, since flat panel televisions that can be mounted to a wide variety of wall and ceiling surfaces have recently experienced an increased availability, popularity, affordability, and use, particularly in commercial settings, they now pave the way for new and innovative ways to provide advertising in a more focused way, such as that provided by the present invention disclosure herein

Although frames and accessories currently exist for mounting flat panel televisions into a desired position of use, two methods have been previously used by others for mounting a frame or accessory to a flat panel television. One involves the use of straps with attached hook-and-loop fasteners or buckles to position a frame or accessory in front of a flat panel television. The other involves bolting the frame or accessory directly to the vertical surface supporting the flat panel television. The disadvantage of using straps and buckles is that they cannot control the placement or orientation of the frame or accessory on the flat panel television, and results in no more attachment of a frame or accessory to the associated flat panel television than a pair of trousers is attached to a person with a belt. Also, disadvantages of mounting a frame or accessory directly to the wall behind a flat panel television is that it involves skilled labor and incurs an expensive price tag. Also, the frame must be precisely placed or its misplacement will be continually evident thereafter in the orientation of the frame against the flat panel television. A recessed enclosure built into the wall avoids this problem but incurs greater expense regarding labor and construction. Furthermore, although the direct-to-the-wall method provides an acceptable level of security, it elevates the cost of maintenance and service for the flat panel television, as skilled labor is generally required for removal of the frame or accessory before the service or maintenance can be started, and again after it is complete. The present invention overcomes the mounting disadvantages of the known prior art by providing a simple and low-cost mounting option, and further provides a benefit not recognized in the prior art of others, that of using a frame around the viewing area of a flat panel television for advertising to a targeted demographic. No system or method is known having the same structural features and advantages of the present invention.

### BRIEF SUMMARY OF THE INVENTION

The primary objective of this invention to provide a static ad frame that can be anchored or fastened vertically and horizontally around the viewing area of a flat panel television to advertise, promote, market, and/or convey a message to individuals viewing content on the flat panel television, including that which reaches a targeted demographic with relevant and content-rich high resolution and high definition printed media that can be seen in any location where a flat panel television is, or could be, located.

It is also an objective of this invention to provide a signboard that is easily mounted anywhere a flat panel television can be mounted.

It is a further objective of this invention to provide a flat panel television and a static ad frame that have a secure means of connection to one another.

It is also an objective of this invention to provide signboard informational content in two formats, content of a general nature, or content specific to a targeted demographic via high definition print media that allows advertisers to present their products in a more focused way to audiences more likely to want to purchase their goods or services.

It is a further objective of this invention to provide a securely mounted static ad frame that is simple to install and use, and offers a low cost option for those wanting a new source of self-promotion or revenue stream.

It is also an objective of this invention to provide a signboard with a printable surface usable for establishing a permanent message for viewers of the associated flat panel television, or in the alternative a signboard with an erasable surface that facilitates impromptu and dynamic messages/advertising/artwork in association with a flat panel television.

It is also an objective of this invention to provide a signboard that is made from lightweight and rigid materials, which can also be substantially flat, solid, have cutouts, and/or have at least one 3-dimensional feature.

A further objective of this invention is to provide a signboard that has accommodation for an infrared relay device, so as to maintain remote control functionality in the associated flat panel television.

It is a further objective of this invention to provide a static ad frame that is usable around flat panel televisions in areas frequently by the public, such as but not limited to restaurants, bars, medical offices, airports, amusement parks, arenas, theaters, and stadiums.

It is also an objective of this invention to provide a signboard that is made from lightweight materials such as but not limited to foam core board, dry erase board, plastic, and/or metal.

It is a further objective of this invention to provide a static ad frame that blocks no content on the viewing area of the associated flat panel television, results in no degradation of flat panel television performance as a consequence of its use, and further results in no loss of flat panel television functionality.

The present invention, when properly made and used, provides a static ad frame that can be used as a signboard vertically and horizontally around the viewing area of a flat panel television to advertise, promote, market, and/or convey a message to individuals viewing content on the flat panel television. The signboard content can be of a general nature, or specific to a targeted demographic. The present invention is a flat device, not unlike a frame, and is preferably made from lightweight and rigid material having a printable surface, such as but not limited to foam core board, dry erase board, which is attached via anchoring/fastening means directly to the front of a flat panel television housing around its viewing area. Since the present invention signboard is lightweight and attached to the front of a flat panel television housing, and no content on the viewing area is blocked, no degradation of flat panel television performance occurs as a result of signboard use, and there is no loss of flat panel television functionality (such as but not limited to remote control functionality). Images and/or words can be used on the printable surface, wherein the printable surface content is seen both actively and passively by individuals while they are viewing the content on the flat panel television. Furthermore, as a result of the present invention's location only a few inches away from the area where a person's attention is focused, messages/content printed on the present invention will continue to be seen both actively and passively as long as it remains in its usable position. No other inventions used with flat panel televisions are known with the same structural features and low cost option advantage as the present invention.

The description herein provides preferred embodiments of the present invention but should not be construed as limiting its scope. Variations, other than those shown and described herein, may also be incorporated into the present invention, such as but not limited to the distance the present invention signboard extends beyond the front perimeter of the associated flat panel television, its thickness, the materials from which it is made, the type and number of 3-dimensional features added to its front surface, if any, and the number, size, spaced-apart placement, configuration, and type of fasteners used to secure the present invention signboard to the front surface of a flat panel television. Thus, the scope of the present invention static ad frame should be determined by the appended claims and their legal equivalents, rather than being limited to the examples given.

### BRIEF DESCRIPTION OF THE SEVERAL VIEWS OF THE DRAWINGS

The sole illustration provided with this invention disclosure is an exploded view showing the most preferred embodiment of the present invention signboard positioned in front of a flat panel LCD/plasma television, with anchoring/attachment means associated with the rear of the present invention signboard and the front of the flat panel television.

### DETAILED DESCRIPTION OF THE INVENTION

When the present invention static ad frame is used, it would provide a signboard 1 that can be used vertically and horizontally around the viewing area 4′ of a flat panel television 2 to provide informational content 3 (referred to in the accompanying illustration as ‘marketing or advertising graphic’) that advertises, promotes, markets, and/or conveys a message to individuals viewing content on the flat panel television 2. Signboard 1 has a central opening 4 corresponding in size and configuration to the viewing area 4′ of a flat panel television targeted for use therewith, and further configured so that no content on the flat panel television becomes blocked by signboard 1 use. The informational content 3 of signboard 1 may be of a general nature, or specific to a targeted demographic, as needed by its owner. In addition, the present invention signboard 1 can have a printable surface usable for establishing informational content 3 in permanent form for viewers of an associated flat panel television 2, or in the alternative signboard 1 may optionally have an erasable surface that provides informational content 3 facilitating impromptu and dynamic messages/advertising/artwork in association with a flat panel television 2. Although not limited thereto, when informational content is in a permanent printed form, it is preferred for it to be content-rich, as well as high resolution and high definition. In addition, although not shown in the accompanying illustration, the informational content 3 on the printable surface of the present invention signboard 1 may contain images, words, or a combination thereof, with such informational content 3 being seen both actively and passively by individuals while they are viewing the content on the associated flat panel television 2. Furthermore, lightweight cutouts 6 (such as, but not limited to, the size, shape, positioning, and number shown in the accompanying illustration) can be optionally added to the present invention signboard 1 to enhance informational content 3 by providing a 3-dimensional effect, and accommodation (such as, but not limited to, the opening 5 shown in the accompanying illustration) for an infrared relay device could also be added to maintain the remote control functionality of the flat panel television 2 associated with the face-mounted present invention signboard 1.

Thus, present invention signboard 1 is typically a flat device, not unlike a frame, which is preferably made from lightweight and rigid material having a printable surface, such as but not limited to foam core board, dry erase board, plastic, and/or metal, and which further becomes attached to the front housing of a flat panel television 2 (vertically and horizontally around its viewing area 4′) via anchoring/fastening means 7, which can include (but is not limited to) hook-and-look fasteners and/or double-sided adhesive. No content on the viewing area 4′ of the flat panel television 2 is blocked by the positioning of the present invention signboard 1, no degradation of flat panel television 2 performance occurs as a result of present invention use, and no loss of flat panel television 2 functionality is experienced when the present invention signboard 1 is used. Furthermore, as a result of the present invention's location only a few inches away from the viewing area 4′ of a flat panel television 2 (where a person's attention is primarily focused), self-promoting messages/content and/or revenue-generating messages/content printed on the present invention will be continually seen (both actively and passively) as long as the present invention signboard 1 remains in its usable position attached to the front housing of a flat panel television 2. Although in the accompanying illustration, present invention signboard 1 is shown to be attached to the front housing of an associated flat panel flat panel television 2 via four pieces of anchoring/fastening/attachment material 7, the number of individual fasteners used is not critical, and should be determined at a minimum to provide a secure connection between the present invention signboard 1 and its associated/supporting flat panel flat panel television 2 without unnecessary expense. Also, the size, configuration, placement, spaced-apart distance therebetween, and type of anchoring/fastening/attachment material 7 used may be different from that shown in the accompanying illustration. Furthermore, signboard 1 can be made from a single piece of material having a printable surface appropriately configured for the intended use, or have a multi-part construction.

We claim:

1. A static ad frame used with flat panel televisions and other types of digital displays having a front viewing area for actively and passively distributing advertising, promotional, and marketing messages to individuals viewing content on the flat panel television or digital display, said static ad frame comprising:
a rigid signboard having a central opening corresponding in size and configuration to the viewing area of a flat panel television or digital display targeted so that, when said signboard is placed against a flat panel television or digital display, no content on the flat panel television or digital display is blocked, said signboard also configured to extend vertically and horizontally fully around the viewing area, said signboard also being made from lightweight materials having a printable front surface; and
fastening means adapted for securing said signboard to a flat panel television or digital display without blocking content thereon, wherein when said printable surface is configured with text, images, and combinations thereof, said printable surface can be used to both actively and passively advertise, promote, market, and convey a message to individuals viewing content on the targeted flat panel television or digital display.

2. The static ad frame of claim 1 wherein said signboard and said fastening means are configured so as to cause no degradation of flat panel television or digital display performance as a result of their use.

3. The static ad frame of claim 1 wherein said signboard and said fastening means are configured so as to cause no loss of flat panel television or digital display functionality as a result of their use.

4. The static ad frame of claim 1 wherein said printable surface is configured to display permanently marked images and words and images.

5. The static ad frame of claim 4 wherein said words and images are selected from a group consisting of content-rich images, content-rich words, high resolution images, high resolution words, high definition images, and high definition words.

6. The static ad frame of claim 1 wherein said printable surface is configured to be erasable so as to facilitate the display thereon of impromptu and dynamic advertising and artwork.

7. The static ad frame of claim 1 wherein said signboard further comprises at least one 3-dimensional feature.

8. The static ad frame of claim 7 wherein said at least one 3-dimensional feature further comprises at least one cut-out.

9. The static ad frame of claim 1 wherein said signboard further comprises at least one accommodation for an infrared relay device on a flat panel television or digital display, with said accommodation configured to prevent loss of infrared relay device functionality.

10. The static ad frame of claim 9 wherein said accommodation comprises at least one opening through said signboard.

11. The static ad frame of claim 1 wherein said signboard has unitary construction.

12. The static ad frame of claim 1 wherein said fastening means is selected from a group consisting of hook-and-loop fasteners and double-sided adhesive.

13. The static ad frame of claim 1 wherein said printable surface is configured to display permanently marked images and words and images selected from a group consisting of content-rich images, content-rich words, high resolution images, high resolution words, high definition images, high definition words, and further wherein said fastening means is selected from a group consisting of hook-and-loop fasteners and double-sided adhesive.

14. The static ad frame of claim 13 wherein said signboard further comprises at least one 3-dimensional feature.

15. A method for advertising, promoting, marketing, and conveying a message to individuals viewing content on a flat panel television or digital display, said method comprising the steps of:
providing the static ad frame of claim 1 and a flat panel television and other type of digital display having a front viewing area;
aligning said central opening of said signboard with said viewing area of said flat panel television or digital display so that said signboard extends vertically and horizontally fully around said viewing area and no content on said flat panel television or digital display is blocked; and
using said fastening means to secure said signboard to said flat panel television or digital display so that said central opening sand said viewing area remain aligned, wherein when said printable surface is configured with text, images, and combinations thereof, those viewing content on said viewing area of said flat panel television or digital display will also both actively and passively view said text, images, and combinations thereof, placed onto said printable surface.

16. The method of claim 15 wherein said text and images are selected from a group consisting of content-rich images, content-rich words, high resolution images, high resolution words, high definition images, and high definition words.

17. The method of claim 15 wherein said printable surface is configured to be erasable so as to facilitate the display thereon of impromptu and dynamic advertising and artwork.

18. The method of claim 15 wherein said signboard further comprises at least one 3-dimensional feature.

19. The method of claim 15 wherein said signboard further comprises at least one accommodation for an infrared relay device on a flat panel television or digital display, with said accommodation configured to prevent loss of infrared relay device functionality.

20. The method of claim 15 wherein said signboard has unitary construction and said fastening means is selected from a group consisting of hook-and-loop fasteners and double-sided adhesive.
